(19) United States
(12) Patent Application Publication
(10) Pub. No.: US 2004/0121109 A1
(43) Pub. Date: Jun. 24, 2004

(54) Process for manufacturing composite profiles

(76) Inventor: Richard N. Anderson, Whitesville, KY (US)

Correspondence Address: CAMORIANO & ASSOCIATES, 8225 SHELBYVILLE ROAD, LOUISVILLE, KY, 40222, US

(21) Appl. No.: 10/695,177

(22) Filed: Oct. 28, 2003

Related U.S. Application Data
(60) Provisional application No. 60/434,891, filed on Dec. 20, 2002.

(51) Int. Cl. B44C 1/26; B29C 65/00; B29C 47/02; B32B 3/08

(52) U.S. Cl. 428/67; 264/248; 264/171.13

(57) ABSTRACT

A process for making a composite profile may take advantage of the properties of two different materials, such as their strength, holding properties, ability to be readily coated or processed, and cost. In a preferred embodiment, the process makes use of a crush rib to ensure that the parts are flush with each other. In another preferred embodiment, the process makes use of a gap between the insert and the core, filling the gap with a coating.

This application claims priority from U.S. Provisional Application S/No. 60/434,891 filed Dec. 20, 2002.

### BACKGROUND

The present invention involves forming a profile from two or more different materials to make a composite profile with an outside appearance of a single piece, while sharing the desirable characteristics of the individual materials in the composite profile. The materials in the composite may be dissimilar materials, such as Medium Density Fiberboard (MDF) and wood.

### SUMMARY

The purpose of the present invention is to fabricate a profile, such as a stile for a window shutter, which is made substantially from one core material, such as MDF, while also including one or more insert components, such as wooden inserts. The core material may have its own desirable characteristics, such as being easy to coat with a thermoplastic resin, being inexpensive, or being able to be processed easily. Similarly, the insert may have other desirable characteristics, such as providing good beam strength and/or providing better holding power than the core material for hinge screws or for assembly screws.

The fabricating process may further include the coating of the composite profile with a skin, such as a thermoplastic extrusion, which covers the outside surfaces of the profile, to give the visual impression of a single piece of homogeneous construction. The profile is visually attractive due to the coating; it is relatively inexpensive, since a substantial portion of the profile is made from inexpensive material, and it has good beam strength, good column strength, good screw holding characteristics, or other desired characteristics, because of the strategically placed insert(s). In some embodiments, the coating also serves to enhance the bond between the core and the insert(s).

The manufacturing process may be designed such that the process of inserting the composite profile through the extrusion die assists in bringing the dissimilar materials together to an exact position, relative to each other, to enhance the impression of a single, homogeneous piece. In a preferred embodiment, this is accomplished by incorporating crush ribs between the core and the insert. The crush ribs literally crush or deform to provide the needed room for the insert to go into the core just the right distance to provide a flush exterior finish of the insert and the core.

One or more of the materials in the profile may be hygroscopic materials, which may expel gases and vapors as they are heated during the production process. In a preferred embodiment, these profiles are coated with a hot thermoplastic extruded skin, such as a polypropylene coating, which covers the outside surfaces of the profile. Coating hygroscopic materials has been a problem in the past, with the escaping gases causing poor adhesion of the coating.

By using a composite profile, a large portion of the surface area to be coated may be made of a material that is less hygroscopic and less likely to encounter problems when it is coated by a hot thermoplastic material.

In addition, U.S. utility patent application Ser. No. 10/232,452, filed Aug. 30, 2002, and titled Process for Applying Coatings, which is hereby incorporated by reference, describes a continuous process for forming an envelope or coating over a core that may expel gases and vapors as it is heated during the production process. This process may be used in the present invention to treat any remaining surfaces of the profile that would benefit from such treatment. As disclosed in the patent application referenced above, heat and/or a high speed, high volume air stream is applied across the surface of the material to be coated in order to drive off the gases that would have been formed during the coating process and that would have interfered with adhesion of the coating.

The air stream also cools down the substrate, so that the internal portions of the substrate will not reach high enough temperatures during the coating process to cause further expulsion of gases. A preferred embodiment of the present invention takes advantage of this method for applying coatings to manufacture a composite profile which is inexpensive and less labor intensive than composite profiles manufactured in the prior art.

### BRIEF DESCRIPTION OF THE DRAWINGS

FIG. 1 is a section view through a core used in a prior art process;

FIG. 2 is a section view through the core of FIG. 1, with end pieces added to the core;

FIG. 3 is an end view of the core and end pieces of FIG. 2 after machining;

FIG. 4 is an end view of the core and end pieces of FIG. 3 after side pieces have been added;

FIG. 5 is an end view of the product of FIG. 4 after it has been machined;

FIG. 6 is an exploded end view of the product of FIG. 5;

FIG. 7 is a sectional view of a composite profile made in accordance with the present invention;

FIG. 8 is an end view of the core of the composite profile of FIG. 7;

FIG. 9 is an end view of the insert of the composite profile of FIG. 7;

FIG. 10 is an enlarged view of detail 10 in FIG. 8;

FIG. 11 is an enlarged view of detail 11 in FIG. 7;

FIG. 12 is an enlarged view of detail 12 in FIG. 7;

FIG. 13 is a sectional view of a second embodiment of a composite profile made in accordance with the present invention;

FIG. 14 is an enlarged view of detail 14 in FIG. 13;

FIG. 15 is a sectional view of another embodiment of a composite profile made in accordance with the present invention; and

FIG. 16 is a sectional view of the core of the composite profile of FIG. 15.

### DESCRIPTION OF THE PREFERRED EMBODIMENTS

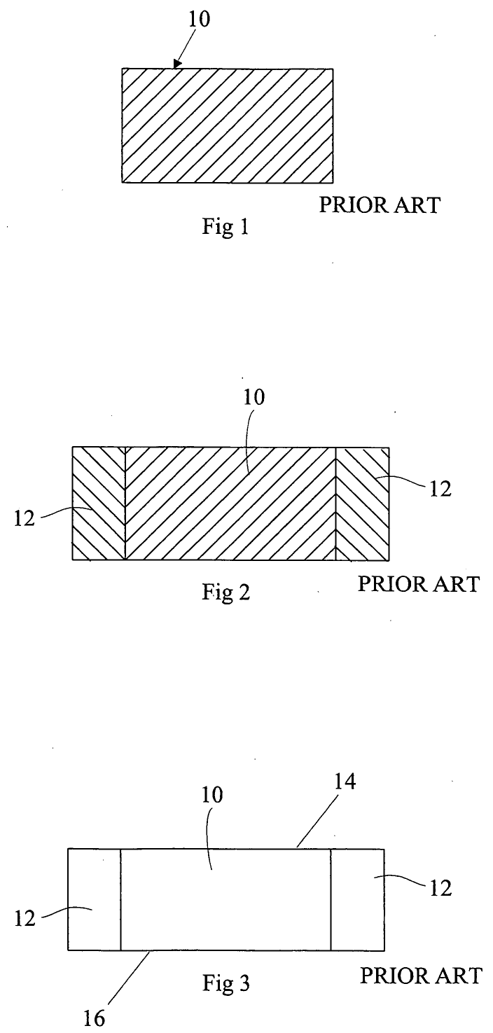

FIGS. 1 through 6 depict a typical prior art manufacturing process for a composite profile 9 (shown in FIGS. 5 and 6), wherein the core 10 is likely a wooden core or some other hygroscopic material which may expel gases and vapors as it is heated during the production process. If the profile 9 will ultimately be coated with a skin coating such as a thermoplastic polypropylene extrusion, the core 10 first is wrapped with a non-hygroscopic material to avoid the problems of poor adhesion or blistering of the coating. This process of wrapping the core 10 is depicted in FIGS. 1 through 5.

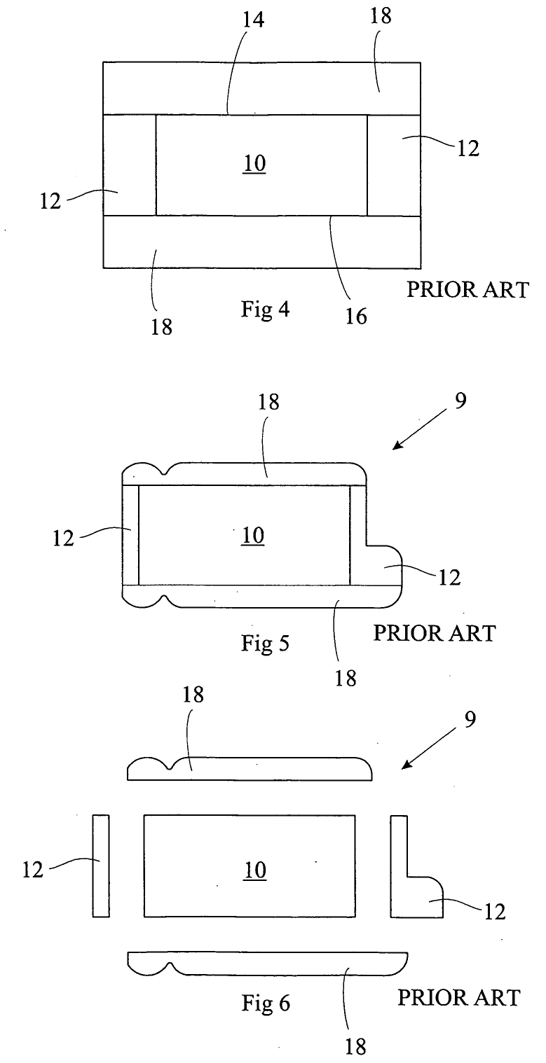

In FIG. 1, the core 10 is cut to the desired size. In FIG. 2, two end pieces 12 are glued onto the ends of the core 10. This sub-assembly, including the end pieces 12 and the core 10, is then cut or machined to size to obtain smooth top and bottom surfaces 14 and 16, respectively, as shown in FIG. 3. Two side pieces 18 are then glued to the smooth top and bottom surfaces 14, 16, as shown in FIG. 4. Finally, the assembly is machined again to the finished dimensions, obtaining the desired profile 9 as shown in FIG. 5. FIG. 6 shows an exploded view of the profile 9. This wrapped profile 9 may then be coated with a thermoplastic material without encountering adhesion problems due to escaping vapors, since the pieces 12, 18 are not made of hygroscopic materials. As may be appreciated, this process is very labor intensive and very time consuming, as it requires multiple gluing steps, time waiting for the glue to dry, and multiple machining steps.

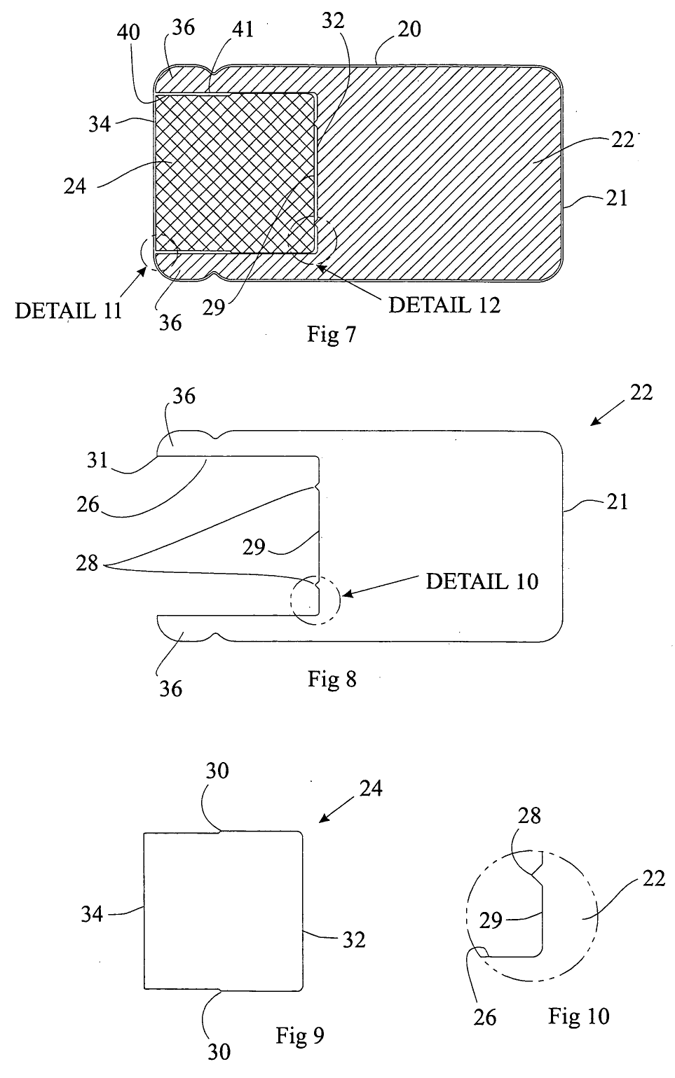

FIG. 7 shows a composite profile 20 made in accordance with the present invention. The profile 20 includes a core 22, shown in more detail in FIGS. 8 and 10, and an insert 24, shown in more detail in FIG. 9. In this embodiment, the core 22 is made from medium density fiberboard (MDF), and the insert 24 is made from wood. Since the medium density fiberboard is easily coated with the thermoplastic material, only the exposed surface of the wooden insert will be treated by the process described in the referenced patent application prior to coating.

The size and shape of the core 22 and of the insert 24 may vary as required to obtain the desired physical characteristics of the profile 20, such as beam strength, column strength, cost, hygroscopic properties, and screw holding capabilities. Although this embodiment only shows a single insert, there may be more than one insert 24. The material for the core 22 is likely to be a less expensive material, such as MDF, while the material for the insert 24 is more likely to be a more expensive material, such as wood. However, these material choices may be reversed if it makes sense to do so (that is, the core 22 may be wood and the insert 24 may be MDF), or other materials may be used for obtaining other desired traits of the profile 20, such as lighter weight, for instance.

FIG. 8 shows the core 22, which, in this embodiment, is made from a piece of MDF machined to the desired finished dimensions and including a U-shaped channel 26 open to one end of the core 22. The U-shaped channel has two legs 36, a bottom 29, and an open top 31. It is understood that the core 22 has the same profile along its entire length. Two V-shaped crush ribs 28, shown in more detail in FIG. 10, project from the bottom of the channel 26 toward the open end 31 of the core 22. The height of the V-shaped crush ribs 28, from the base 29 to the point of the V, usually is in the range of 0.01 to 0.05 inches.

FIG. 9 is a sectional view or an end view of the insert 24 of FIG. 7 prior to its insertion into the core 22. Again, the insert 24 has the same profile along its entire length. This insert 24 is made out of wood and is approximately rectangular in cross section except for two shoulders 30 along the sides of the insert 24, which make the base 32 of the insert 24 slightly wider than the top 34 of the insert 24. The dimensions of the insert are such that the base 32 fits snugly between the legs 36 of the channel 26, and the height of the insert 24, as measured from the base 32 to the top 34, is slightly less than the depth of the U-shaped channel 26 from the base 29 to the open end 31 and slightly greater than the distance between the tops of the crush ribs 28 and the open top 31 of the channel 26.

FIG. 7 shows the assembly of the profile 20 with the insert 24 lodged inside the channel 26, such that the base 32 of the insert 24 is adjacent the bottom 29 of the channel 26, and the top 34 of the insert 24 is flush with the top 31 of the core 22. FIG. 12 shows that the upper tip of the V-shaped crush rib 28 has been crushed by the bottom 32 of the insert 24. The insert 24 preferably is inserted into the channel 26 by inserting the base 32 of the insert into the open top of the channel 26, moving it toward the crush ribs 28 and crushing the crush ribs 28 sufficiently to make the upper edges 31, 34 flush with each other.

In the preferred manufacturing process, the elongated core 20 and insert 24 are placed adjacent and parallel to each other, with the base 32 of the insert 24 directed toward the open channel 26 of the core 20. Then, a set of guiding rollers (not shown), which aligns and directs the profile toward the entry plate of the extrusion die (for applying the skin coating), applies pressure to the bottom 21 of the core 20 and to the top 34 of the insert 24 so as to push the insert 24 into the channel 26 of the core 22 until the top 34 of the insert 24 is flush with the top edge 31 of the core 22. In the process, the crush ribs 28 are crushed or deformed to allow the insert 24 to move into the channel 26 the desired distance until the outer surfaces of the insert 24 and of the core 22 are flush.

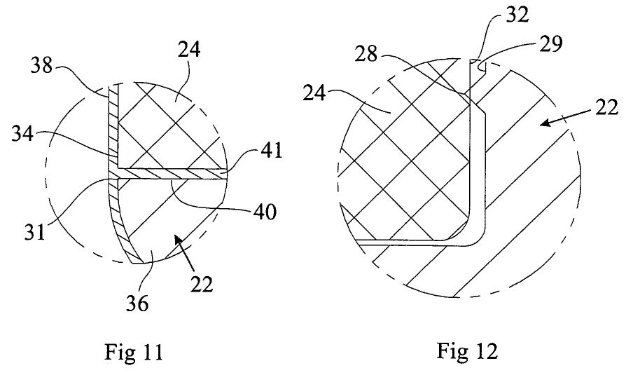

Finally, the profile 20 passes through the extrusion die (not shown), where it is coated with a skin 38, such as a thermoplastic polypropylene coating 38, as shown best in FIG. 11. Since the base 32 of the insert 24 is wider than the top 34, a gap 40 is formed between the sides of the insert 24 and the legs 36 of the core 20 down to the shoulders 30. This gap 40 is seen in FIGS. 7 and 11. When the profile 20 is being coated, some of the coating 38 enters into the gap 40, where it solidifies and cures.

The thermoplastic polypropylene coating 38 in this embodiment has a higher bonding affinity for the MDF than for the wood. This is especially true for any surfaces of the wood which have not been pre-treated just prior to the coating process with the heat and/or air knife procedure outlined in the referenced patent application, such as the sides and the bottom of the insert 24. The sides and bottom of the insert 24 are not treated immediately prior to coating, because these surfaces are already inside the channel 26 of the core 22.

As the coating 38 enters the gap 40 and fills the void between the insert 24 and the core 22, it forms a plug 41, having a strong bond with the MDF. This plug 41 traps the insert 24 by preventing the wider shoulders 30 of the insert 24 below the plug from moving outwardly to separate the insert from the core. Thereafter, in order for the insert 24 to be pulled out from the core 22, the plug of coating 38 would have to be sheared, or it would have to separate from the MDF, with which it has a strong bond. Thus, despite potentially poor adhesion between the coating 38 and any surfaces of the insert 24 that are not pretreated with heat and/or an air knife just prior to coating, the insert 24 is secured to the core 22 with all the adhesive strength that the coating 38 has for the MDF core.

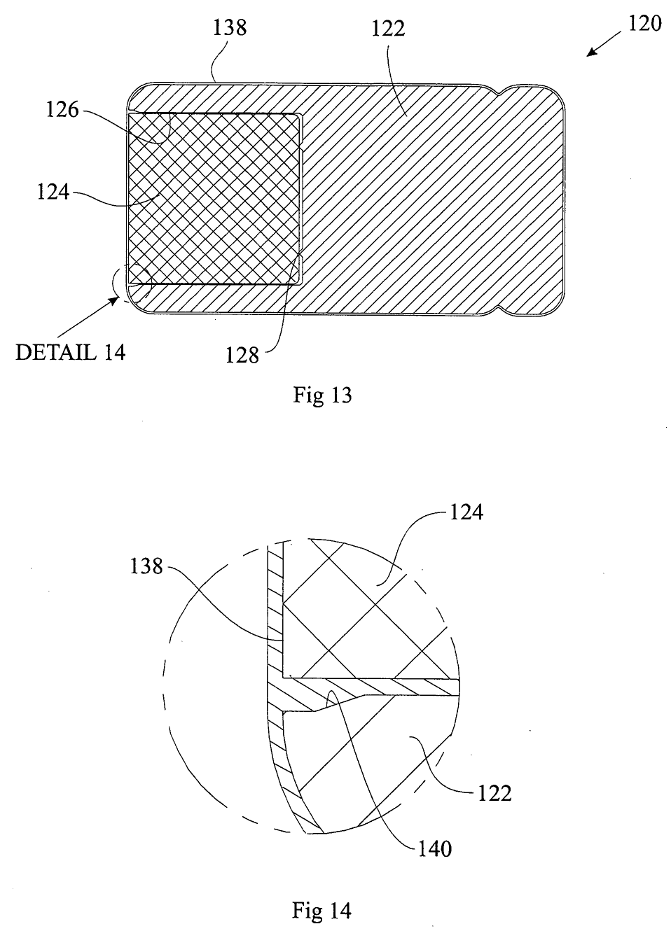

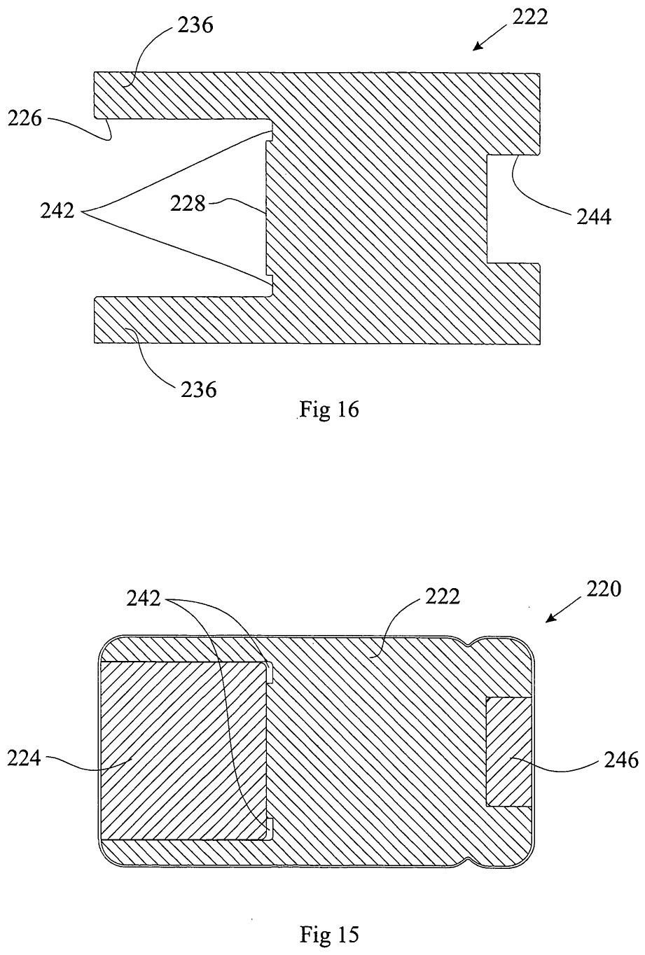

FIGS. 13 and 14 show another embodiment of a composite profile 120, including a core 122 and an insert 124. In this embodiment, the insert 124 has a substantially rectangular cross-section, without the shoulders 30 of the previous embodiment. This has the advantage of not having to do the extra machining of these shoulders on the insert 124. Instead, the U-shaped channel 126 of the core 122 is widened slightly at the outer ends to form the gap 140, shown best in FIG. 14. As with the previous embodiment, there is a wider gap between the core and the insert 124 near the outer surface of the insert 124 than farther into the core 122. The profile 120 is assembled in the same manner as the previously described profile 20, with guide rollers pressing the insert 124 against crush ribs 128 at the bottom of the channel 126 of the core 122 and the profile 120 then entering the extrusion die for applying the coating 138. The coating 138 again flows into the gap 140, where it solidifies and cures to provide additional coating thickness which must be sheared in order to remove the insert 124, and this additional thickness is adjacent the top portion of the insert 124, which has benefited from the heat and/or air knife pretreatment to enhance the bonding characteristics of the coating 138 to the insert 124.

The profile 120 of this embodiment is less expensive to manufacture than the profile 20 of the first embodiment, because it requires less handling and machining of the insert 124. However, the integrity of the bond between the insert 124 and the core 122 is not as good. FIGS. 15 and 16 show another embodiment that improves the bond.

In FIGS. 15 and 16, the composite profile 220 includes a core 222 and inserts 224, 246. To improve the bond, small amounts of glue are applied to the inside of the legs 236 of the core 222 prior to inserting the insert 224 into the channel 226, such that, when the insert 224 is assembled into the channel 226, the glue is smeared and spread over the contact surfaces between the core 222 and the insert 224. Shallow pockets 242 extend lengthwise along the bottom of the channel 226 adjacent the legs 236, and these pockets 242 are a repository for any extra glue which may have been applied.

However, certain materials, such as MDF, are hydrophilic, and they will absorb moisture from the glue. As a result, they may expand unevenly, resulting in a bowing of the profile 220. To counter this uneven expansion, glue may be applied to the opposite end of the core 222, so that it also absorbs a similar amount of moisture and thus cancels out any residual stresses which may cause the piece to bow.

However, the glue preferably should not be applied to a surface which will be extrusion coated, because the glue may then cause poor adhesion and blistering of the coating. The solution disclosed in this embodiment of the profile 222 is to machine a second channel 244 opposite the first channel 226, and to provide a second insert 246 to go inside this second channel 244. The purpose of this second channel 246 is to provide a surface for the application of the glue to counter the glue applied in the first channel 226. The purpose of the second insert 246 is to cover the second channel 246 so that the glue is not exposed to the coating. The second insert 246 may be of the same material as the core 222, such as MDF, or it may be of the same material as the first insert 224, such as wood, or it may of a third distinct material. The second insert 246 may also be designed so that it contributes to the desired attributes of the composite profile 220, such as improved beam strength, improved column strength, improved screw holding power, and/or lighter weight.

It should be noted that, as long as the core is being machined anyway, it makes sense to make the crush ribs integral to the core. However, the crush ribs 28, 128, 228 need not be an integral part of the core 22, 122, 222. They may instead be an integral part of the inserts 24, 124, 224, 246, or they may even be separate pieces.

It should also be noted that, where the composite profiles use a hygroscopic material for either the core or the insert(s), and at least one surface of said hygroscopic material is in direct contact with the extruded coating, that surface preferably should be pretreated with the heat and/or air knife process disclosed in the Process for Applying Coatings patent application prior to the coating process.

While several embodiments of the present invention have been shown and described, it is not practical to describe all the possible variations and combinations that could be made within the scope of the present invention. It will be obvious to those skilled in the art that modifications may be made to the embodiments described above without departing from the scope of the invention as claimed.

What is claimed is:

1. A process for making a composite profile, including at least one core piece and one insert piece, each having a top surface and a bottom surface, and a first end and an opposite second end, wherein said core piece defines a first channel sized to receive said insert piece, comprising the steps of:
providing a crush rib between the bottom surface of the insert piece and the channel; and
pressing said insert piece into said first channel to deform the crush rib until the top surfaces of the insert and the core are aligned.

2. A process for making a composite profile as recited in claim 1, and further comprising the step of coating the assembled core and insert with a polymeric coating.

3. A process for making a composite profile as recited in claim 2, wherein said coating is a thermoplastic and is applied by passing said assembled core and insert through an extrusion die.

4. A process for making a composite profile as recited in claim 2, and further comprising the step of providing a wider gap between the insert and the core near the top than further into the core and applying coating into that wider gap.

5. A process for making a composite profile as recited in claim 4, wherein said wider gap is formed by providing a recessed shoulder on said insert.

6. A process for making a composite profile as recited in claim 4, wherein said wider gap is formed by making the channel wider at the top edge than at the bottom.

7. A process for making a composite profile as recited in claim 2, wherein said insert piece further defines at least one side surface, and said side surface defines at least one recessed shoulder, forming a gap between said core piece and said insert piece above said recessed shoulder, and wherein said gap is filled with said coating.

8. A process for making a composite profile as recited in claim 2, wherein said channel of said core piece defines at least one leg extending from said bottom surface to said top surface of said core piece, and said leg widens adjacent said top surface of said core piece to define a gap between said leg of said core piece and said insert piece, and wherein said gap is filled with said coating.

9. A process for making a composite profile as recited in claim 1, wherein said channel defines at least one leg, and said insert piece defines at least one side surface, and further comprising the step of applying adhesive to at least one of said leg and said side surface prior to pressing said insert piece and said core piece together.

10. A process for making a composite profile as recited in claim 9, wherein said bottom surface of said core piece defines at least one shallow pocket to act as a repository for any extra adhesive applied.

11. A process for making a composite profile as recited in claim 9, and further comprising the step of applying adhesive along an opposite second end of said core piece so as to counter uneven expansion due to moisture absorption by said core piece from said adhesive.

12. A process for making a composite profile as recited in claim 11, and further comprising the steps of:
providing a second channel along said opposite second end of said core piece; and
inserting a second insert piece into said second channel.

13. A process for making a composite profile as recited in claim 12, wherein said second channel defines a second bottom surface, and said second bottom surface defines at least one shallow pocket to act as a repository for any extra adhesive applied.

14. A composite profile, comprising:
a core piece, having a top surface which is partially unrecessed and which is partially recessed to define a channel;
an insert piece, having a top and a bottom, said insert piece being received inside said channel, with the top of said insert piece coplanar with the unrecessed top surface portion of said core piece; and
a crush rib between the bottom of said insert piece and said core piece, said crush rib being partially deformed.

15. A composite profile as recited in claim 14, wherein said crush rib is an independent piece, separate from said core piece and said insert piece.

16. A composite profile as recited in claim 14, wherein said crush rib is a projection from one of said core piece and said insert piece.

17. A composite profile as recited in claim 16, wherein said crush rib is an upward projection from said core piece.

18. A composite profile as recited in claim 14, and further comprising a polymeric coating surrounding said core piece and said insert piece.

19. A composite profile as recited in claim 18, wherein there is a gap between said core piece and said insert piece adjacent said top surface, and wherein said gap is filled by said coating.

20. A composite profile as recited in claim 19, wherein said insert piece has side surfaces that are closer together at the top than in a further recessed position, thereby forming said gap.

21. A composite profile as recited in claim 20, wherein said insert piece defines a recessed shoulder.

22. A composite profile as recited in claim 19, wherein said channel defines sides that are wider apart at the top than in a further recessed position, thereby forming said gap.
